(19) United States
(12) Patent Application Publication
(10) Pub. No.: US 2015/0252663 A1
(43) Pub. Date: Sep. 10, 2015

(54) FLOWABLE COMPOSITION, METHOD FOR PRODUCING THE FLOWABLE COMPOSITION AND METHOD FOR FRACKING A SUBTERRANEAN FORMATION USING THE FLOWABLE COMPOSITION

(71) Applicant: WINTERSHALL HOLDING GMBH, Kassel (DE)

(72) Inventor: Vladimir Stehle, Kassel (DE)

(21) Appl. No.: 14/431,886

(22) PCT Filed: Sep. 25, 2013
(86) PCT No.: PCT/EP2013/070010

§ 371 Date: Mar. 27, 2015

(30) Foreign Application Priority Data
Sep. 27, 2012 (EP) 12186280.9
Jun. 4, 2013 (EP) 13170402.5

(51) Int. Cl. E21B 43/263; C06B 23/00; C09K 8/68

(52) U.S. Cl. CPC E21B 43/263; C09K 8/68; C06B 23/009

(57) ABSTRACT

A free-flowing composition (FC) comprising at least one fuel component (F), at least one oxidizing agent (O) and a glucan (G) having a β-1,3-glycosidically linked main chain and side groups β-1,6-glycosidically bonded thereto, the fuel component (F) and/or the oxidizing agent (O) being in liquid form.

The present invention relates to a free-flowing composition (FC), to a process for producing the free-flowing composition (FC) and to a process for fracking an underground formation using the free-flowing composition (FC).

The free-flowing composition (FC) can be used for development of shale gas deposits, of tight gas deposits, of shale oil deposits, of oil deposits in impervious reservoirs, of bitumen and heavy oil deposits, using “in situ combustion”, gas extraction from coal formations, underground gasification of coal seams, mining of ore deposits, underground leaching in metal extraction, release of rock pressure and modification of stress fields in geological formations, water production from underground deposits, and for development of underground geothermal deposits.

In the development of the aforementioned deposits, it is common practice to hydraulically fracture parts of the underground formation, in order to increase the flow of fluids into and/or out of the underground formation. Hydraulic fracturing (or fissuring of an underground formation), fracking for short, is understood to mean the occurrence of a fracture event in the rock surrounding a well as a result of the hydraulic action of a liquid or gas pressure on the rock of the underground formation.

In the last few years, water-based fracking has become ever more important. This involves using fracking fluids comprising water, gel formers and optionally crosslinkers. The use of crosslinkers leads to spontaneous gel formation within a few minutes. In the case of water-based fracking, a fracking fluid is injected under high pressure through an injection well into the rock stratum to be fractured or fissured.

The fracking fluid is pumped into the stratum to be fractured or fissured at a pressure sufficient to divide or fracture the underground formation. This widens natural fissures and cracks present, which have been formed in the course of evolution of the geological formation and in the event of subsequent tectonic movements, and produces new cracks, crevices and fissures, also called fracs or hydrofracs. Proppants such as sand may be added to the fracking fluid.

The alignment of the hydrofracs thus induced depends particularly on the state of stress existing in the underground formation. The pressure level with which the fracking fluid is pumped into the formation depends on the properties of the rocks and the stress fields in the underground formation. A disadvantage of these processes is that the water-based fracking fluid has to be injected into the underground formation with enormously high pressures, and so these processes are inconvenient and costly. Furthermore, only very limited fissuring of the underground formation is possible by water-based fracking, since the pressure of the fracking fluid injected cannot be increased without limitation.

An additional disadvantage of the hydraulic fracking process is that large amounts of fracking fluid have to be introduced into the underground formation, as a result of which, for example, mineral oil deposits are watered down by the fracking fluid introduced. The fracking fluids are subsequently difficult to remove and the crevices and fissures formed are frequently blocked by the fracking fluid introduced. In the case of underground rock formations having a high density, the efficiency of the hydrofracking process is extremely low. The hydrofracking process is additionally very inconvenient and costly.

In order to achieve greater fissuring of underground formations, the prior art describes free-flowing explosives. These are typically introduced into a vessel, and the vessel comprising the free-flowing explosive is subsequently detonated by means of a detonator.

RU 2084806 describes an explosive charge consisting of a vessel filled with a liquid explosive. Hydrocarbons are used as the fuel component, and dinitrogen tetroxide as the oxidizing agent. The explosion of the vessel is initiated by an electrical detonator. A disadvantage of the explosive described in RU 2084806 is that dinitrogen tetroxide is a highly toxic and additionally volatile substance. The production of the explosive is hazardous and the detonation of the explosive must immediately follow the production of the mixture.

RU 2174110 likewise describes a vessel filled with a liquid fuel component and a liquid oxidizing agent. The oxidizing agent and the fuel component are separated from one another in the vessel by means of a separating wall. Immediately prior to the initiation of the explosion, the separating wall in the vessel is removed, as a result of which the fuel component and the oxidizing agent mix. Disadvantages of the explosive described in RU 2174110 are that the performance of the explosive charge is only low and the handling of the explosive described in RU 2174110 is hazardous.

RU 2267077 describes a free-flowing explosive introduced into a hermetic vessel without a separating wall. The fuel component used is passivated aluminum powder or magnesium powder coated with an oxide layer. The oxidizing agent used is water. The metal powder sediments in the hermetic vessel within very short periods and is stable in the sedimented state in the water used as the oxidizing agent over prolonged periods. Immediately prior to the detonation of the explosive, the metal powder is suspended in the water used as the oxidizing agent. For this purpose, the vessel is agitated. As well as water, the following further oxidizing agents can be used: nitrogen acids, dinitrogen tetroxide, hydrogen peroxide and aqueous solutions of ammonium nitrate and/or urea. A disadvantage of the explosive described in RU 2267077 is that the metal powder as the fuel component sediments in the liquid oxidizing agent within a very short time. However, the explosion of the explosive is only reliably ensured when the metal powder is suspended homogeneously in the oxidizing agent. Due to the relatively high sedimentation rate, the explosive described in RU 2267077 does not always ensure reliable detonation of the explosive, particularly when long horizontal wells are to be fissured.

Studies have shown that the specific heat of explosion of the above-described explosive comprising metal powder is within the range from 7000 to 14000 kJ/kg. The specific heat of explosion is thus much higher than the heat of explosion of liquid explosives which do not comprise any metal powder. Through the change in the ratios of metal powder to liquid oxidizing agent, it is possible to control the amount of energy which is released in the explosion. It is also possible to adjust the ratios between metal powder and liquid oxidizing agent such that no explosion takes place, but the metal powder and oxidizing agent instead burn off rapidly and turbulently, forming large amounts of gas. This process is also referred to as deflagration. The explosion energy can additionally be controlled via the size of the metal particles.

The above-described explosives are preferably used for development of oil and gas deposits and for mining of ore deposits. The explosives can be used here in deep vertical wells and in deep horizontal wells. The efficient use of the explosives described, especially in the case of use in deep horizontal wells, however, has the disadvantages which follow.

As described above, the metal powders used as the fuel component tend to rapidly sediment in the liquid oxidizing agent. As a result, operation of the above-described explosives is unreliable, since reliable detonation of the explosive after sedimentation is not always ensured.

In order to slow the sedimentation of the metal powders used as the fuel component, the prior art additionally describes the use of thickeners to increase the viscosity of the free-flowing explosives. The thickeners described in the prior art, however, have the disadvantage that the thermal stability thereof is unsatisfactory. Operation of the free-flowing explosives described in the prior art is unreliable, especially in wells with high temperatures. As a result of the high temperatures, the viscosity of the free-flowing explosive decreases, as a result of which the sedimentation rate of the metal powder used as the explosive rises in turn, and so reliable detonation of the explosive is not always ensured. A further disadvantage of the free-flowing explosives described in the prior art is that, in the case of use in wells containing formation water having a high salt content, the viscosity of the free-flowing explosives is likewise lowered considerably, as a result of which the explosive can fail.

An additional effect of the fall in the viscosity in wells having high temperatures or wells containing formation water having a high salt content is that the free-flowing explosive can mix with the formation water present in the well. The change in the concentration of the free-flowing explosive resulting from the mixing with the formation water present in the well, or the sedimentation of the metal powder used as an explosive component, can likewise lead to the failure of the explosive.

There was therefore a need for improved compositions suitable for fracking of underground formations, and for improved processes for fissuring (fracking) of underground formations, which have the disadvantages of the compositions and processes described in the prior art only to a reduced degree, if at all.

It was an object of the present invention to provide a free-flowing composition which has the disadvantages of the explosives described in the prior art only to a reduced degree, if at all, and can be used for fracking of an underground formation. It is a further object of the present invention to provide an improved process for fracking of underground formations, with which effective fissuring of an underground formation is achieved.

This object is achieved in accordance with the invention by a free-flowing composition (FC) comprising at least one fuel component (F), at least one oxidizing agent (O) and a glucan (G) having a β-1,3-glycosidically linked main chain and side groups β-1,6-glycosidically bonded thereto, the fuel component (F) and/or the oxidizing agent (O) being in liquid form.

The free-flowing composition (FC) can be made to react exothermically by means of a detonator, causing the fuel component (F) to react with the oxidizing agent (O) with evolution of gas and heat.

Depending on the fuel (F) used and the oxidizing agent (O) used, the exothermic reaction may proceed in the form of a detonation, an explosion or a deflagration. This means that the rate of the exothermic reaction can be regulated.

“Detonation” is understood in accordance with the invention to mean the instantaneous conversion of the potential energy present in the free-flowing composition (FC) to form a shock wave, the shock wave attaining speeds between 1000 and 10 000 m/s, temperatures in the range from 2500 to 6000° C. and pressures in the range from 10 000 to 300 000 bar. “Explosion” is understood in accordance with the invention to mean the instantaneous conversion of the potential energy present in the free-flowing composition (FC) to form a shock wave, the shock wave attaining speeds in the range from >100 m/s to <1000 m/s, temperatures in the range from 2500 to 6000° C. and pressures in the range from 1000 to 300 000 bar. “Deflagration” is understood in accordance with the invention to mean the rapid combustion of the free-flowing composition (FC), the combustion spreading with inhomogeneous speed of at most 100 m/s.

The inventive free-flowing composition (FC) enables the fracking of an underground formation and hence effective establishment or improvement of hydrodynamic connections between the well and the productive strata present in the underground formation.

“Free-flowing” in the present context means that the free-flowing composition (FC), or the free-flowing tamping composition, can be pumped into the well by means of conventional pumping.

“Fracking” is understood in accordance with the invention to mean the controlled induction of a fracture event in the rock surrounding a well. The fracture event is induced by the pressure which arises in the detonation, the explosion or the deflagration. The fracking causes fissuring of the rock surrounding the well.

### Free-Flowing Composition (FC)

According to the invention, the composition comprises at least one fuel component (F) and at least one oxidizing agent (O). Thus, the free-flowing composition (FC) may comprise exactly one fuel component (F), but it is also possible to use a mixture of two or more fuel components (F). Hereinafter, the term “fuel component (F)” comprises exactly one fuel component (F) and mixtures of two or more fuel components (F). The free-flowing composition (FC) may, in accordance with the invention, comprise exactly one oxidizing agent (O), but it is also possible that the free-flowing composition (FC) comprises two or more oxidizing agents (O). Hereinafter, the term “oxidizing agent (O)” is understood to mean exactly one oxidizing agent (O) and mixtures of two or more oxidizing agents (O).

According to the invention, the fuel component (F) and/or the oxidizing agent (O) are in liquid form. The free-flowing composition (FC) may thus comprise a liquid oxidizing agent (O) and a liquid fuel component (F). It is also possible that the free-flowing composition (FC) comprises a solid oxidizing agent (O) and a liquid fuel component (F). However, the free-flowing composition (FC) preferably comprises a solid fuel component (F) and a liquid oxidizing agent (O).

The present invention thus provides a free-flowing composition (FC) in which the fuel component (F) is solid and the oxidizing agent (O) liquid.

Examples of suitable oxidizing agents (O) include water, dinitrogen tetroxide (N₂O₄), peroxides such as hydrogen peroxide, ammonium nitrate, nitrogen acids such as nitric acid (HNO₃), and chlorates. The oxidizing agent (O) is preferably liquid. A particularly preferred oxidizing agent (O) is water, to which may optionally be added further oxidizing agents (O). A preferred further oxidizing agent (O) is ammonium nitrate.

The present invention thus also provides a free-flowing composition (FC) in which the oxidizing agent (O) used is water. The present invention further provides a free-flowing composition (FC) in which the oxidizing agent (O) used is an aqueous ammonium nitrate solution.

The free-flowing composition (FC) comprises a glucan (G) as a thickener. Preferably, the glucan (G) comprises a main chain composed of β-1,3-glycosidically linked glucose units and pendant groups composed of glucose units β-1,6-glycosidically bonded thereto. The pendant groups preferably consist of a single β-1,6-glycosidically attached glucose unit, with a statistical average of every third unit of the main chain β-1,6-glycosidically bonded to a further glucose unit. Particular preference is given to schizophyllan.

Schizophyllan has a structure according to the formula (I) where n is a number in the range from 7000 to 35 000.

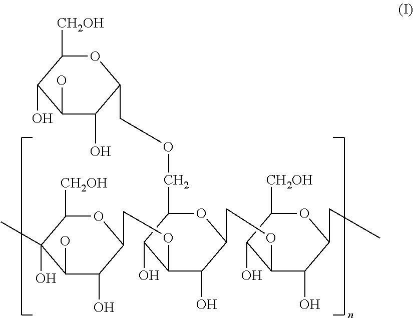

The glucans (G) used in accordance with the invention are secreted by fungal strains. Such fungal strains which secrete glucans (G) are known to those skilled in the art.

Preferably, the fungal strains are selected from the group consisting of Schizophyllum commune, Sclerotium rolfsii, Sclerotium glucanicum, Monilinia fructigena, Lentinula edodes and Botrytis cinera. Suitable fungal strains are additionally mentioned, for example, in EP 271 907 A2 and EP 504 673 A1. More preferably, the fungal strains used are Schizophyllum commune or Sclerotium rolfsii and most preferably

Schizophyllum commune. This fungal strain secretes a glucan (G) in which a statistical average of every third unit of the main chain is β-1,6-glycosidically bonded to a further glucose unit in a main chain composed of β-1,3-glycosidically bonded glucose units; in other words, the glucan (G) is preferably that called schizophyllan.

The fungal strains are fermented in a suitable aqueous medium or nutrient medium. The fungi secrete the abovementioned glucans (G) into the aqueous medium in the course of fermentation.

Methods for fermenting the abovementioned fungal strains are known in principle to those skilled in the art, for example from EP 271 907 A2, EP 504 673 A1, DE 40 12 238 A1, WO 03/016545 A2 and Udo Rau, “Biosynthese, Produktion and Eigenschaften von extrazellularen Pilz-Glucanen” [Biosynthesis, Production and Properties of Extracellular Fungal Glucans], Habilitation Thesis, Technical University of Braunschweig, 1997. Each of these documents also describes suitable aqueous media or nutrient media.

The glucan (G) used has a weight-average molecular weight (M_{G}) in the range from 1.5*10⁶ to 25*10⁶ g/mol, preferably in the range from 5*10⁶ to 25*10⁶ g/mol, and can be prepared, for example, by the process described in WO 2011/082973.

The free-flowing composition (FC) may optionally additionally comprise further thickeners. Examples of suitable further thickeners include synthetic polymers, for example polyacrylamide or copolymers of acrylamide and other monomers, especially monomers having sulfo groups, and polymers of natural origin, for example other glucans, xanthan or diutans.

The free-flowing composition (FC) comprises generally 10 to 500 g of the fuel component (F) per liter of free-flowing composition (FC) and 0.1 to 5 g of glucan (G) per liter of free-flowing composition (FC). The present invention thus also provides a free-flowing composition (FC) in which the concentration of the fuel component (F) is in the range from 10 to 500 g/l of free-flowing composition (FC) and the concentration of the glucan (G) is in the range from 0.1 to 5 g/l of free-flowing composition (FC).

The free-flowing composition (FC) may additionally comprise further additives. Examples of suitable further additives include glycerol, preferably crude glycerol, salts such as sodium or calcium chloride, biocides and surfactants.

Biocides can be added to prevent polymer degradation by microorganisms. In addition, it is possible to add oxygen scavengers, for example sodium bisulfide, in which case it is additionally possible to add basic compounds such as alkali metal hydroxides.

The surfactants used may be nonionic, anionic or zwitterionic surfactants. The addition of surfactants allows the surface tension of the free-flowing composition (FC) to be reduced, as a result of which better distribution in the underground formation is achieved. Preference is given to nonionic and/or anionic surfactants. Suitable surfactants comprise, as the hydrophobic molecular moiety, especially hydrocarbyl radicals, preferably aliphatic radicals having 10 to 36 carbon atoms, preferably having 12 to 36 carbon atoms and more preferably having 16 to 36 carbon atoms. Examples of such surfactants comprise ionic surfactants having sulfo groups, such as olefinsulfonates such as a-olefinsulfonates or i-olefinsulfonates, paraffinsulfonates or alkylbenzenesulfonates, nonionic surfactants such as alkyl polyalkoxylates, especially alkyl polyethoxylates and alkyl polyglucosides. One example of zwitterionic surfactants is alkylamidopropylbetaine. Further suitable surfactants are those which have nonionic hydrophilic groups and anionic hydrophilic groups, for example alkyl ether sulfonates, alkyl ether sulfates or alkyl ether carboxylates.

The free-flowing composition (FC) generally has viscosities in the range from 100 to 1500 cP, preferably in the range from 200 to 1000 cP and more preferably in the range from 300 to 800 cP. The viscosities reported were measured on a rotary viscometer (Physika MCR 301) under shear stress control with double slit geometry (PG 35/PR/A1) at a shear rate of 7 s⁻¹.

The inventive composition (FC) may thus be a free-flowing explosive (FS) or a free-flowing deflagrant (FD). In one embodiment, the free-flowing composition (FC) is not a thermite composition, thermite compositions being compositions which comprise a metal as the fuel component and an oxide of a metal other than the fuel component as the oxidizing agent, for example a mixture of iron oxide and aluminum.

Suitable fuel components (F) are, for example, hydrocarbons, such as kerosene or mineral oil, and pulverulent metals and/or pulverulent metal alloys.

Preferred fuel components (F) are pulverulent metal alloys or pulverulent metals. It is optionally possible to add further fuel components (F), for example kerosene, to the pulverulent metal alloys or pulverulent metals.

The present invention thus also provides a free-flowing composition (FC) in which the fuel component (F) used is a pulverulent metal alloy and/or a pulverulent metal.

Preferred metals are magnesium, calcium and aluminum, particular preference being given to magnesium and aluminum, especially aluminum. Preferred metal alloys are alloys of the aforementioned metals, to which further metals may optionally be added.

The pulverulent metal alloy used as the fuel or the pulverulent metal preferably has a particle size of <100 μm. The present invention thus also provides a free-flowing composition (FC) in which the pulverulent metal alloy or the pulverulent metal has a particle size of ≦100 μm. Preference is given to particle sizes in the range from 1 to 100 μm, more preferably in the range from 1 to 50 μm and especially preferably in the range from 1 to 30 μm. Through the particle size of the solid fuel component (F), it is possible to control the intensity (rate) of the exothermic reaction of the free-flowing composition (FC). Smaller particles lead to a more intense, faster reaction and hence to greater fissuring of the underground formation.

The fuel component (F) used is preferably a pulverulent metal (metal powder). A preferred metal powder is aluminum powder, magnesium powder or a mixture of aluminum powder and magnesium powder. A preferred fuel component (F) is aluminum powder having a particle size of ≦100 μm. Preference is given to particle sizes of the aluminum powder in the range from 1 to 100 μm, more preferably in the range from 1 to 50 μm and especially preferably in the range from 1 to 30 μm.

The present invention thus also provides a free-flowing composition (FC) in which the fuel component (F) used is aluminum powder, magnesium powder or a mixture of aluminum powder and magnesium powder.

The above-described pulverulent metal alloys and pulverulent metals can be produced, for example, using vibratory mills. The advantage of vibratory milling lies in the dry fine comminution of the metals or metal alloys used. Vibratory milling also enables chemomechanical activation of the material being ground, achieving chemical or physicochemical conversions of matter. Typically, the metals or metal alloys used in the milling are used with an initial particle size not exceeding 20 mm. Depending on the particle size used in the initial material and the milling time, particle sizes in the range from 1 to 5 pm can be achieved.

Aluminum and magnesium are particularly suitable for vibratory milling, since these metals can be comminuted relatively easily. Preference is given to aluminum.

The free-flowing composition (FC) enables homogeneous distribution of the solid fuel (F) in the liquid oxidizing agent (O). The solid fuel component (F) remains homogeneously distributed in the liquid oxidizing agent (O) over prolonged periods and gives lasting prevention of sedimentation of the solid fuel component (F). In addition, the free-flowing composition (FC) is stable even in underground formations having high temperatures, for example temperatures in the range from 60 to 140° C., which means that the viscosity of the free-flowing composition (FC) does not decrease and sedimentation of the solid fuel component (F) is prevented, in a lasting manner in some cases.

In addition, the free-flowing composition (FC) is also stable in underground formations in which formation water having a high salt content is present. The stability of the free-flowing composition (FC) under the deposit conditions additionally effectively prevents mixing with formation water present in the deposit. This allows use of the free-flowing composition (FC) also in underground formations comprising formation water, without dilution of the free-flowing composition (FC). This ensures reliable detonation of the free-flowing composition (FC).

Formation water, also called deposit water, is understood in the present context to mean water present in the deposit. This may be water present in the underground formation. Formation water in the present context is also understood to mean flood water which may have been injected into the underground formation, for example in the course of secondary or tertiary production processes.

### Process for Producing the Free-Flowing Composition (FC)

The present invention therefore also provides a process for producing the free-flowing composition (FC), comprising the steps of
i) mixing at least one solid fuel component (F) and at least one liquid oxidizing agent (O) to obtain a mixture in which the solid fuel component (F) is distributed homogeneously in the liquid oxidizing agent (O),
ii) mixing the glucan (G) into the mixture from step a) to obtain the free-flowing composition (FC).

In relation to the solid fuel component (F), the liquid oxidizing agent (O) and the glucan (G), the details and preferences given above with regard to the free-flowing composition (FC) apply correspondingly.

According to the invention, the fuel component (F) and the liquid oxidizing agent (O) are mixed until homogeneous distribution of the solid fuel component (F) in the liquid oxidizing agent (O) has been attained. The mixing can be performed in mixing apparatuses known to those skilled in the art, such as stirred tanks with a propeller stirrer or dissolver disk. On attainment of a homogeneous distribution, without interrupting the mixing operation, the glucan (G) is added, with stepwise or continuous reduction in the intensity of the mixing operation.

Subsequently, mixing is continued until the viscosity of the free-flowing composition (FC) has fully developed. The mixing of the free-flowing composition (FC) can be performed above ground, and the free-flowing composition (FC) thus obtained can be stored there. In underground mines, the production of the free-flowing composition (FC) can also take place underground. In the case that the oxidizing agent (O) used is water, it is possible to use pure water, seawater, partly desalinated seawater or formation water. The use of formation water is preferred, since glucan (G), in contrast to conventional thickeners, is insensitive to salts present in the formation water.

### Process for Fracking an Underground Formation

The present invention also provides a process for fracking an underground formation, comprising at least the steps of
a) sinking at least one well (1) into the underground formation,
b) optionally introducing a free-flowing tamping composition (5) into the well,
c) introducing the free-flowing composition (FC) into the well,
d) detonating the free-flowing composition (FC) in the well by means of a detonator.

The sinking of at least one well (1) into the underground formation is effected by conventional methods known to those skilled in the art and is described, for example, in EP 0 952 300. The well (1) is preferably a directional well comprising a quasi-vertical and a quasi-horizontal section. The quasi-vertical and quasi-horizontal sections of the well (1) are joined to one another by a curved part. The quasi-horizontal part of the well (1) is preferably introduced into a productive stratum (2) of the underground formation, the angle of inclination of the quasi-horizontal section of the well (1) following the angle of inclination of the productive stratum (2) of the underground formation.

The quasi-vertical part of the well (1) can be stabilized by a feed tube (7). It is also possible to stabilize sections of the quasi-horizontal part of the well (1) by means of a feed tube (7). Typically, however, only the section of the well (1) which is not to be subsequently fracked is stabilized permanently by a feed tube (7). According to the invention, in step b), a free-flowing tamping composition (5) is introduced into the quasi-horizontal section of the well (1). The length of the quasi-vertical section of the well (1) may vary within wide ranges and depends on the length of the productive stratum (2) in the underground formation. The length of the quasi-vertical section of the well (1) is generally in the range from 100 to 10 000 m, preferably in the range from 100 to 4000 m, more preferably in the range from 100 to 2000 m, especially in the range of 100 to 1000 m.

The length of the quasi-horizontal section of the well (1) likewise depends on the position of the productive stratum in the underground formation which is to be fracked and may vary within wide ranges. The length of the quasi-horizontal section of the well (1) is generally in the range from 20 to 5000 m, preferably in the range from 20 to 2000 m, more preferably in the range from 20 to 1000 m.

The free-flowing tamping composition (5) is preferably introduced into the region of the well bottom (3) of the well (1). The region of the well bottom (3) is understood to mean the region which directly adjoins the well bottom (3). The length of the region of the well bottom (3) is generally 0 to 100 m, preferably 0 to 10 m, more preferably 0 to 5 m.

The free-flowing tamping composition (5) used is preferably an aqueous mixture whose viscosity is a factor of 10 to 500 times higher than the viscosity of the formation water (14) present in the well (1). The viscosity of the free-flowing tamping composition (5) is typically in the range from 100 to 1200 cP, preferably in the range from 200 to 800 cP and especially in the range from 300 to 600 cP.

The viscosity of the free-flowing tamping composition (5) is preferably likewise adjusted by a thickener, preferably by a glucan (G). For the glucan (G) present in the tamping composition (5), the details and preferences given above with regard to the free-flowing composition (FC) apply correspondingly.

The free-flowing tamping composition (5) may optionally additionally comprise further additives. For any additives present in the free-flowing tamping composition (5), the details and preferences given above with regard to the free-flowing composition (FC) apply correspondingly.

As a result of the elevated viscosity of the free-flowing tamping composition (5), formation water (14) present in the well (1) is displaced in a piston-like manner from the region of the well bottom (3) in the direction of the well head.

After introduction of the free-flowing tamping composition (5), according to process step c), the free-flowing composition (FC) is subsequently introduced into the region of the well bottom (3) of the well (1). The viscosity of the free-flowing composition (FC) is preferably adjusted such that the free-flowing composition (FC) has a viscosity 1.1 to 5 times higher than the viscosity of the free-flowing tamping composition (5).

As a result, the free-flowing composition (FC) displaces the free-flowing tamping composition (5) in the direction of the well head, the free-flowing tamping composition (5) in turn displacing the formation water (14) present in the well (1), likewise in the direction of the well head.

In process step d), a free-flowing detonation mixture (12) is likewise introduced into the region of the well bottom (3), and this subsequently initiates the detonation of the free-flowing composition (FC).

In a preferred embodiment, the free-flowing tamping composition (5), the free-flowing composition (FC) and the free-flowing detonation mixture (12) are introduced into the region of the well bottom (3) via a pipe run (13) (coiled tubing). In a preferred embodiment, during process steps b), c) and d), the coiled tubing (13) is not moved. Prior to the detonation of the free-flowing composition (FC) in the quasi-horizontal section of the well (1), the coiled tubing (13) is removed.

The present invention thus also provides a process in which
b) the free-flowing tamping composition (5) is introduced into the region of the well bottom (3) of the well (1) via a coiled tubing (13), as a result of which formation water (14) present in the well (1) is displaced in the direction of the well head, and, in process step
c) the free-flowing composition (FC) is likewise introduced into the region of the well bottom (3) of the well (1) via the same coiled tubing (13), as a result of which the free-flowing tamping composition (5) and the formation water (14) present in the well (1) are displaced in the direction of the well head, and, in process step
d) the detonator is likewise introduced into the region of the well bottom (3) of the well (1) via the same coiled tubing (13) and the detonation is initiated after removal of the coiled tubing (13) from the well (1).

The free-flowing composition (FC) is detonated in process step d), generally using an electrical or chemical detonator. The detonation is preferably initiated by means of a chemical detonator.

The chemical detonator used is preferably a combination of aqueous acid, preferably aqueous hydrochloric acid, and magnesium granules. To this end, for example, magnesium granules can be introduced into the well (1) in the form of an aqueous suspension and subsequently mixed with aqueous acid in the well (1). This forms a detonation mixture (12) in the well (1), said mixture comprising magnesium granules and aqueous acid.

The aqueous acid used may, for example, be an aqueous hydrochloric acid solution having a hydrochloric acid content in the range from 1 to 38% by volume, preferably in the range from 10 to 25% by volume, more preferably in the range from 15 to 20% by volume.

The reaction of hydrochloric acid with magnesium gives hydrogen and heat, according to the following reaction equation:

2HCl+Mg→MgCl₂+H₂+heat

The chemical reaction of one kilogram of magnesium with hydrochloric acid generates approx. 5000 kcal of heat, and the temperature of the detonation mixture reaches 600 to 800° C. This temperature reliably ensures the detonation of the free-flowing composition (FC).

After the detonation of the free-flowing composition (FC) in the quasi-horizontal section of the well (1), a fissured zone (4) is formed, this having highly fissured regions (4a) and less highly fissured regions (4b).

The fissures formed improve hydrodynamic communication of the productive stratum (2) with the well (1), as a result of which the yield of natural gas and/or mineral oil from the productive layer (2) is effectively increased.

In a preferred embodiment, the performance of the first explosion is followed by performance of a second explosion. For this purpose, a free-flowing composition (FC) is again introduced into the underground formation.

The free-flowing composition (FC) is injected via the well (1) into the fissured zone (4) which has arisen from the first explosion. This fills the cracks and fissures created by the first explosion with the free-flowing composition (FC). The free-flowing composition (FC) is injected into the fissured zone (4) with a pressure not exceeding the hydrodynamic frac pressure. Through the adjustment of the viscosity of the free-flowing composition (FC), it is possible to regulate the penetration depth into the cracks of the fissured zone (4). The viscosity of the free-flowing composition (FC) selected for the second explosion is preferably at a lower level than the viscosity of the free-flowing composition (FC) used for the first explosion.

After the filling of the fissured zone (4) which has formed in the first detonation, the free-flowing composition (FC) in the fissured zone (4) is detonated. The detonation is effected analogously to the first explosion, preferably by means of the detonation mixture described therefor (12). The composition (FC) is injected into the fissured zone (4). For this purpose, in the preserved section of the well, a packer is installed and the composition (FC) is injected into the fissured zone (4) via a pipe run. The cross-sectional diameter of the fissured zone (4) is generally in the range from 2 to 8 m.

After the detonation of the free-flowing composition (FC), a fissured zone (8) having a large volume is formed. The fissured zone (8) functions as a well channel of large diameter in the productive stratum (2) of the underground formation. Gas or mineral oil from the productive stratum (2) subsequently flows into the zone (8). The fissured zone (8) plays the role of a collector. The diameter of the fissured zone (8) is generally in the range from 4 to 20 m.

The fissured zone (8) is surrounded by an adjoining zone (9) having only a low level of fissuring as a result of the detonation of the free-flowing composition (FC).

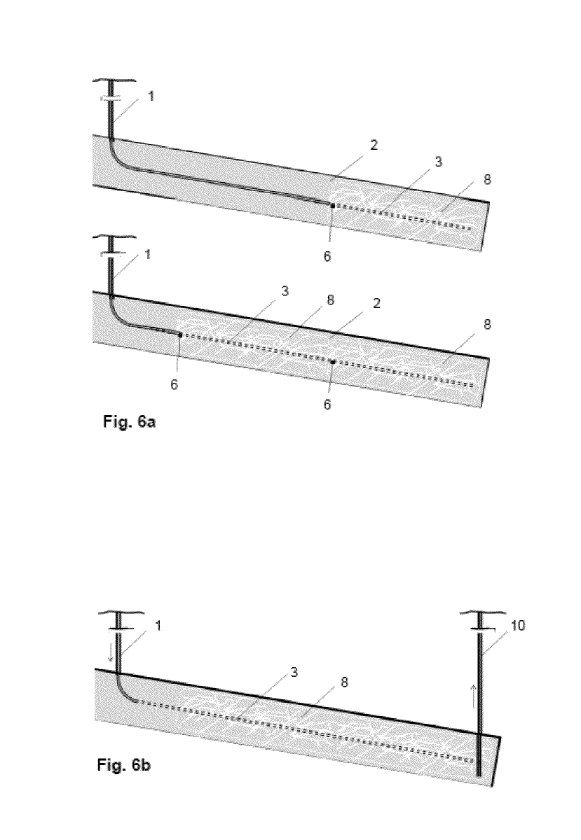

The zones (4) and (8) can also be formed stepwise. The stepwise production of a fissured zone (8) is shown schematically, for example, in FIG. 6a).

The gas or mineral oil production can be continued by conventional methods after the performance of the process according to the invention. Gas or mineral oil can be produced through the well (1). It is also possible to sink one or more further wells (10) into the fissured zones (4) or (8) formed by the process according to the invention. The further well (10) may, for example, assume the function of a production well. The well (1) may assume the function of an injection well. It is also possible that the well (1) assumes the function of a production well and the further well (10) the function of an injection well.

The inventive free-flowing composition and the process according to the invention are particularly suitable for development of underground tight gas or tight mineral oil deposits. “Tight gas” and “tight mineral oil” refer, respectively, to natural gas and mineral oil stored in very compact rock.

The invention is illustrated by the figures and examples which follow, without being restricted thereto.

The reference numerals in the present context are defined as follows:

1 well

2 productive stratum of the deposit

3 region of the well bottom

4 fissured zone after the first explosion

4a) highly fissured region of the fissured zone 4

4b) less highly fissured region of the fissured zone 4

5 free-flowing tamping composition

6 packer

7 feed pipe of the well 1

8 fissured zone after the second explosion

9 adjoining zone

10 second well

11 free-flowing composition (FC)

12 detonation mixture

13 pipe run (coiled tubing)

14 formation water

The individual figures show:

FIG. 1

Vertical section of the underground formation after the second explosion

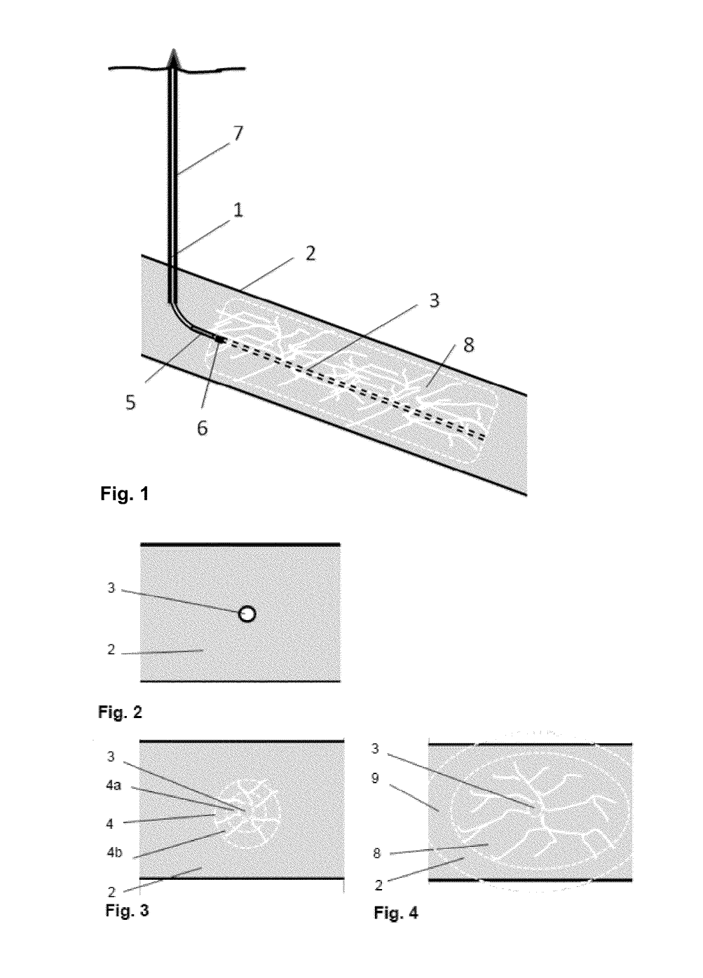

FIG. 2

Cross section through the region of the well bottom 3 in the productive stratum 2 prior to the explosion

FIG. 3

Cross section through the region of the well bottom 3 in the productive stratum 2 after the first explosion

FIG. 4

Cross section through the region of the well bottom 3 in the productive stratum 2 after the second explosion

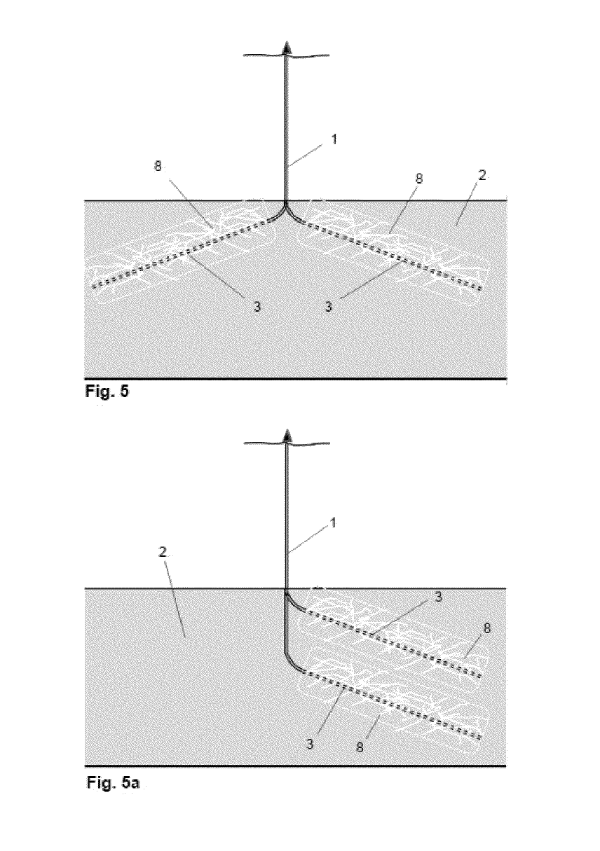

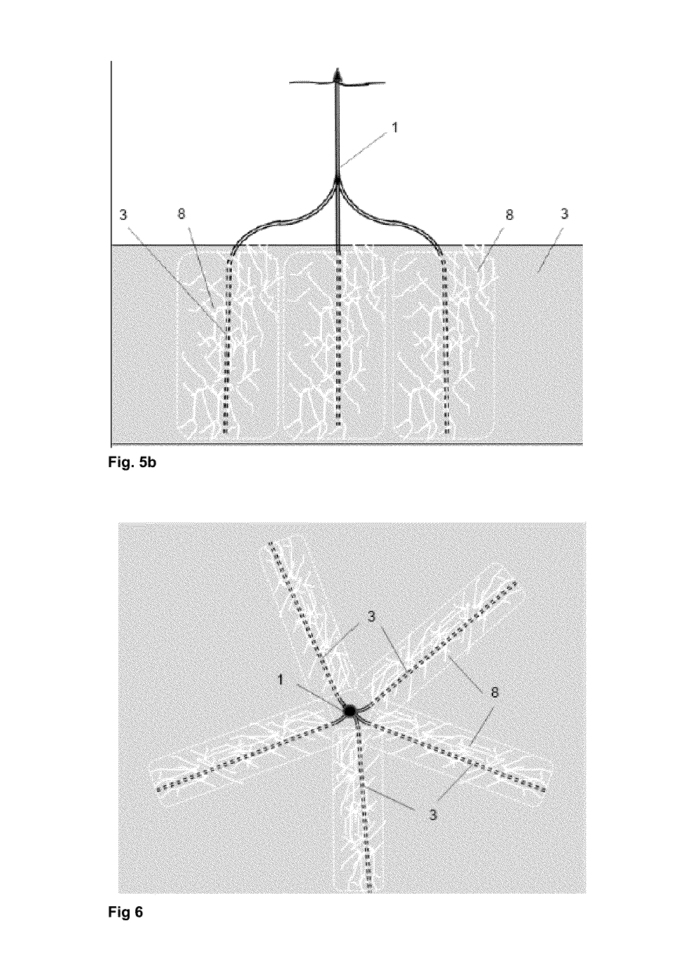

FIGS. 5, 5a, 5b

Vertical section through the underground formation after the second explosion

FIG. 6

Horizontal section of the underground formation after the second explosion

FIG. 6a

Horizontal section through the underground formation after the stepwise fissuring

FIG. 6b

Vertical section through the underground formation with gas or oil production

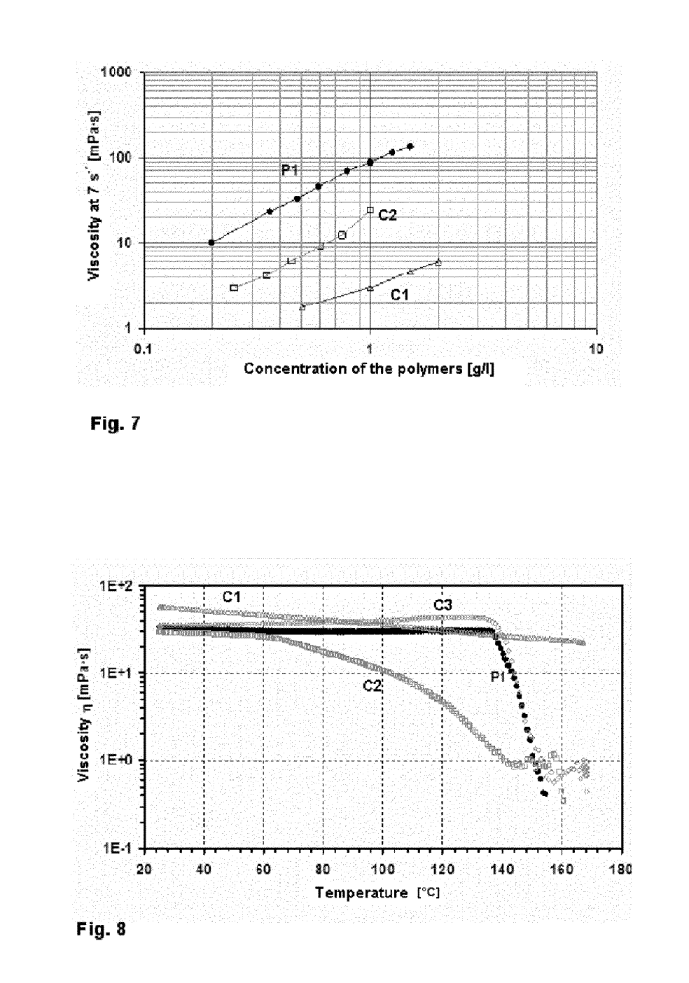

FIG. 7

Dependence of the viscosity of glucan (G) (P1) and of the comparative polymers C1 and C2 on concentration

FIG. 8

Temperature dependence of the viscosity of glucan (G) (P1) and of the comparative polymers C1, C2 and C3 in ultrapure water

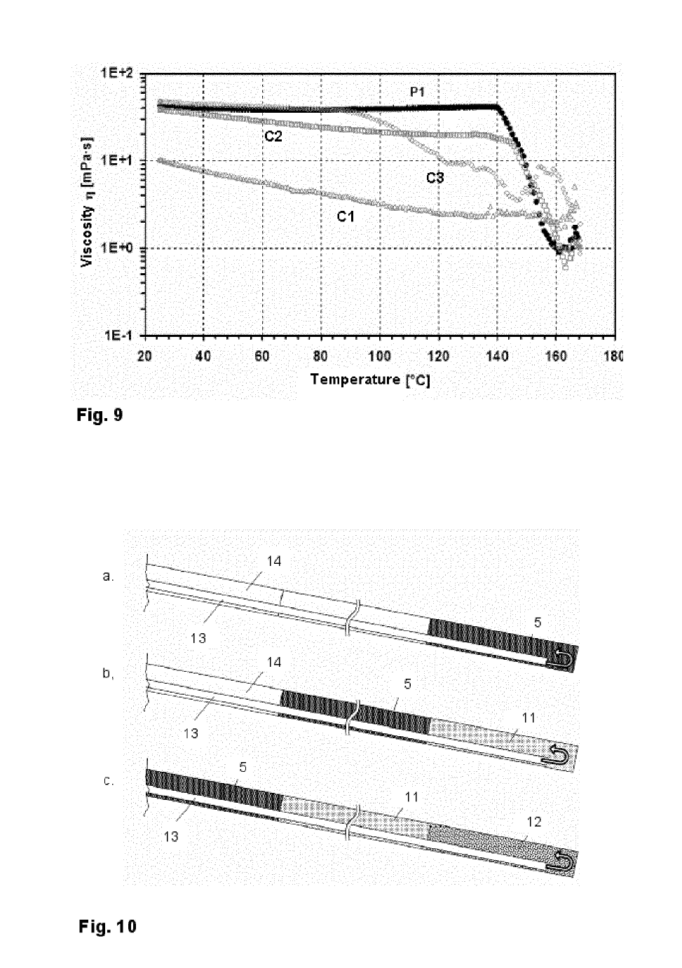

FIG. 9

Temperature dependence of the viscosity of glucan (G) (P1) and of the comparative polymers C1, C2 and C3 in synthetic deposit water

FIGS. 10a, 10b and 10c

Formation phases of the explosive charge in the region of the well bottom 3 of the well 1

FIG. 1 shows a vertical section through an underground formation after the performance of two explosions. The well 1 is stabilized by a feed pipe 7. The explosions have given rise to a fissured zone 8. The previous region of the well bottom 3 is shown by a broken line. Above the fissured zone 8 are a packer 6 and the tamping composition 5. The introduction of a packer is not absolutely necessary. The tamping composition 5 can also be introduced below the packer.

FIG. 2 shows the cross section of the region of the well bottom 3 in the productive stratum 2 prior to the explosion.

FIG. 3 shows the cross section of the region of the well bottom 3 in the productive stratum 2 after the first explosion. The cross section of the region of the well bottom 3 is shown by the broken line. The first explosion gives rise to a fissured zone 4 having a highly fissured region 4a and a less highly fissured region 4b.

FIG. 4 shows the cross section of the region of the well bottom 3 in the productive stratum 2 after the second explosion. The second explosion has formed the fissured zone 8, which is surrounded by the adjoining zone 9 which is less highly fissured.

FIGS. 5, 5a and 5b show cross sections of the underground formation into which wells with several quasi-horizontal sections have been sunk, after the second explosion.

FIG. 6 shows a horizontal section through the underground formation into which several quasi-horizontal wells have been sunk in a starlike manner, after the second explosion.

FIG. 6a shows a vertical section through the underground formation, in which the process according to the invention has been performed stepwise. The upper part of FIG. 6a shows the state after the second explosion. Thereafter, the process according to the invention is performed once again in the as yet unfissured quasi-horizontal section of the well 1, which forms a second fissured zone 8.

FIG. 6b shows a vertical cross section through the underground formation into which a further well 10 has been sunk. The fissured zone 8 serves as a collector. The well 1 serves as an injection well through which a flooding composition is injected into the fissured zone 8. Natural gas or mineral oil is produced via the well 10, which serves as a production well.

FIG. 7 shows the viscosity of the glucan (G) (P1) used in accordance with the invention and of the comparative polymers (C1) and (C2) as a function of concentration. The viscosity measurement was performed at a shear rate of 7 s⁻¹.

FIG. 8 shows the viscosity of the glucan (G) (P1) used in accordance with the invention and of the comparative polymers (C1), (C2) and (C3) in ultrapure water as a function of temperature.

FIG. 9 shows the viscosity of the glucan (G) (P1) used in accordance with the invention and of the comparative polymers (C1), (C2) and (C3) in synthetic deposit water as a function of temperature.

FIG. 10 shows the course of the process according to the invention. In FIG. 10a, the tamping composition 5 is introduced into the region of the well bottom 3 via a pipe run 13 (coiled tubing). The tamping composition 5 displaces the formation water 14 present in the well in the direction of the well head.

In FIG. 10b, the free-flowing composition (FC) 11 is introduced into the region of the well bottom 3 via the same coiled tubing 13. The free-flowing composition (FC) 11 displaces the tamping composition 5, which in turn displaces the formation water 14 in the direction of the well head.

FIG. 10c shows the introduction of the detonation mixture 12 (introduction of magnesium granules, followed by introduction of aqueous hydrochloric acid) via the coiled tubing 13 into the region of the well bottom 3. The detonation mixture 12 displaces the free-flowing composition (FC) 11, which in turn displaces the tamping composition 5 and the formation water 14 in the direction of the well head.

### EXAMPLE 1

### Viscosity Efficiency of Various Polymers

The viscosities of solutions of various polymers were measured at concentrations in the range from 0.2 g/l to 2 g/l. For this purpose, the polymers tested were dissolved in synthetic deposit water or, if the polymer is in the form of a solution, mixed with the synthetic deposit water. The synthetic deposit water (formation water) used was an aqueous solution of the following composition (per liter):

| | | |
|---|---|---|
| CaCl₂ | 42 600 | mg, |
| MgCl₂ | 10 550 | mg, |
| NaCl | 132 000 | mg, |
| Na₂SO₄ | 270 | mg and |
| NaBO₂*₄H₂O | 380 | mg. |
| Total salinity: | 185 750 | mg. |

The polymers used were the inventive glucan (G), a comparative polymer 1 (C1), a comparative polymer 2 (C2) and a comparative polymer 3 (C3).

### Comparative Polymer 1 (C1)

Commercial synthetic polymer of 75 mol % of acrylamide and 25 mol % of the sodium salt of the 2-acrylamido-2-methylpropanesulfonic acid monomer. Comparative polymer (C1) has a weight-average molecular weight M_{w} of approx. 11 million grams/mole.

### Comparative Polymer 2 (C2)

Commercial biopolymer, xanthan (CAS 11138-66-2, produced by fermentation with the bacterium Xanthomonas Campestris) having a weight-average molecular weight N_{w} of approx. two million grams/mole.

### Comparative Polymer 3 (C3)

Commercial biopolymer, diutan (produced by fermentation with the bacterium Sphingomonas sp.)

The measurements of the viscosity of the aforementioned polymers are shown in FIG. 7. In FIG. 7, the inventive glucan (G) is labeled P1. The measurements for glucan (G) (P1) and comparative polymer (C2) were performed at 54° C. The measurement for comparative polymer (C1) was performed at 40° C.

The viscosity measurements were performed in a test cell which simulates the conditions in a deposit. The viscosity measurements were performed as follows:

### Performance of the Viscosity Measurements

Measuring instrument: shear stress-controlled rotary viscometer, Physica MCR301; pressure cell with twin slit geometry DG35/PR/A1

Measurement range: 25° C. to 170° C., as specified in each case.

Shear rate: as specified in each case.

The complete measuring system, including the syringe with which the particular samples were introduced into the rheometer, was purged with nitrogen. During the measurement, the test cell was under a nitrogen pressure of 8 bar.

It is clear from the measurement results shown in FIG. 7 that the inventive glucan (G) (P1) in the synthetic deposit water used in accordance with the invention achieved the best viscosity efficiency; this means that the samples in which glucan (G) was used exhibit the highest viscosity for a given concentration.

### EXAMPLE 2

Solutions of the inventive glucan (G) (P1) and of the comparative polymers (C1), (C2) and (C3) in ultrapure water were produced. The concentration of each of these solutions was 3 g/l. Subsequently, these solutions were introduced into the above-described test cell and analyzed at a shear rate of 100 s⁻¹ within the temperature range from 25° C. to 170° C. The samples were introduced into the test cell at 25° C.; the heating rate was 1° C. per min. The results are shown in FIG. 8.

### EXAMPLE 3

Example 3 was performed analogously to Example 2. Instead of ultrapure water, the polymers were dissolved in the above-described synthetic deposit water. The results of the measurement are shown in FIG. 9.

Examples 2 and 3 show the advantages of the glucan (G) (P1) used in accordance with the invention compared to the comparative polymers (C1), (C2) and (C3) at high temperatures and high salt concentrations in the water used as the solvent. The viscosity of the glucan (G) (P1) remains very substantially constant in water of high salinity and in ultrapure water within the temperature range from 25° C. to 140° C., and begins to decrease gradually only at temperatures above 140° C. In ultrapure water, both comparative polymer (C1) and comparative polymer (C3) show similar behavior. Comparative polymer (C2) also exhibits much poorer viscosity stability in ultrapure water.

If deposit water is used, all comparative polymers (C1), (C2) and (C3), especially at high temperatures, exhibit much poorer viscosity stability than the glucan (G) (P1) used in accordance with the invention (see FIG. 9).

1. A free-flowing composition (FC) comprising
at least one fuel component (F),
at least one oxidizing agent (O) and
a glucan (G) having a β-1,3-glycosidically linked main chain and side groups β-1,6-glycosidically bonded thereto,
the fuel component (F) and/or the oxidizing agent (O) being in liquid form.

2. The free-flowing composition (FC) according to claim 1, wherein the glucan (G) has a weight-average molecular weight M_{w} in the range from 1.5*10⁶ to 25*10⁶ g/mol.

3. The free-flowing composition (FC) according to claim 1, wherein at least one fuel component (F) is solid and at least one oxidizing agent (O) is liquid.

4. The free-flowing composition (FC) according to claim 1, wherein the fuel component (F) used is a pulverulent metal alloy or pulverulent metal.

5. The free-flowing composition (FC) according to claim 1, wherein the fuel component (F) used is aluminum powder, magnesium powder or a mixture of aluminum powder and magnesium powder.

6. The free-flowing composition (FC) according to claim 4, wherein the pulverulent metal alloy or the pulverulent metal has a particle size less than 100 μm.

7. The free-flowing composition (FC) according to claim 1, wherein the oxidizing agent (O) used is water.

8. The free-flowing composition (FC) according to claim 1, wherein the concentration of the fuel component (F) is in the range from 10 to 500 g/l of free-flowing composition (FC) and the concentration of the glucan (G) is in the range from 0.1 to 5 g/l of free-flowing composition (FC).

9. A process for producing a free-flowing composition (FC) according to claim 1, comprising the steps of
i) mixing at least one solid fuel component (F) and at least one liquid oxidizing agent (O) to obtain a mixture in which the solid fuel component (F) is distributed homogeneously in the liquid oxidizing agent (O),
ii) mixing the glucan (G) into the mixture from step a) to obtain the free-flowing composition (FC).

10. A process for fracking an underground formation, comprising at least the steps of
a) sinking at least one well into the underground formation,
b) optionally introducing a free-flowing tamping composition into the well,
c) introducing the free-flowing composition (FC) according to any of claims 1 to 8 into the well,
d) detonating the free-flowing composition (FC) in the well by means of a detonator.

11. The process according to claim 10, wherein the detonation in step d) is initiated by a chemical detonator.

12. The process according to claim 10, wherein the detonation in step d) is initiated by a chemical detonation mixture which comprises aqueous acid and magnesium granules.

13. The process according to claim 10, wherein, in process step
b) the free-flowing tamping composition is introduced into the region of the well bottom of the well via a coiled tubing, as a result of which formation water present in the well is displaced in the direction of the well head, and, in process step
c) the free-flowing composition (FC) is likewise introduced into the region of the well bottom of the well via the same coiled tubing, as a result of which the free-flowing tamping composition and the formation water present in the well are displaced in the direction of the well head, and, in process step
d) the detonator is likewise introduced into the region of the well bottom of the well via the same coiled tubing and the detonation is initiated after removal of the coiled tubing from the well.

14. The process according to claim 10, wherein the tamping composition has a viscosity 10 to 500 times higher than the viscosity of the formation water.

15. The process according to claim 10, wherein the free-flowing composition (FC) has a viscosity 1.1 to 5 times higher than the viscosity of the tamping composition.
